(19) United States
(12) Patent Application Publication
(10) Pub. No.: US 2020/0409484 A1
(43) Pub. Date: Dec. 31, 2020

(54) POINTING DEVICES

(71) Applicant: Hewlett-Packard Development Company, L.P., Spring, TX (US)

(72) Inventors: David H. Hanes, Fort Collins, CO (US); John Michael Main, Fort Collins, CO (US)

(73) Assignee: Hewlett-Packard Development Company, L.P., Spring, TX (US)

(21) Appl. No.: 16/966,444

(22) PCT Filed: Mar. 23, 2018
(86) PCT No.: PCT/US2018/023994

§ 371 Date: Jul. 30, 2020

(51) Int. Cl. G06F 3/0354; G06F 3/16; G06F 3/01; F21V 33/00

(52) U.S. Cl. CPC G06F 3/03543; G06F 3/16; F21W 2111/00; F21V 33/0052; G06F 3/016

(57) ABSTRACT

Examples described herein relate to a pointing device. For instance, a pointing device may comprise a plurality of buttons disposed on a body, a scrolling mechanism to transition between a plurality of configuration categories when the pointing device is in a configuration mode, and a light source to indicate a selected configuration category of the plurality of configuration categories when the pointing device is in the configuration mode.

### BACKGROUND

Input controls may allow a user to interact with and control a computing device (e.g., computers, tablets, etc.). Input controls may include keyboards, pointers, a pointing device, and/or other controls for accepting user interaction. Some input controls, such as pointing devices, may use optical sensors to detect motion on a surface. The detected motion may allow the input control to interact with and control a computing device.

### BRIEF DESCRIPTION OF THE DRAWINGS

FIG. 1 illustrates an example of a pointing device consistent with the disclosure.

FIG. 2 illustrates an example of a pointing device consistent with the disclosure.

FIG. 3 illustrates an example of an apparatus including a pointing device consistent with the disclosure.

FIG. 4 illustrates an example of a pointing device consistent with the disclosure.

FIG. 5 illustrates an example diagram of a medium including a pointing device consistent with the disclosure.

### DETAILED DESCRIPTION

Pointing devices are described herein. Pointing devices may be connected to a computing device to allow for control of the computing device. Depending on the operation of the computing device a change to the configuration of the pointing device may be implemented. Pointing devices may utilize software and other external components to change the configuration of the pointing device. As used herein, software refers to a part of a computing system that includes machine readable instructions. However, the software used to change the configuration of the pointing device may not be compatible with the computing device. In addition, use of an external component to change the configuration of the pointing device may cause a user to temporarily pause their current activity to make configuration changes to the pointing device.

As such, a pointing device, as described herein, may be able to enter and exit a configuration mode without an external component. As used herein, an external component refers to an external application, an external computing device, and/or a device that is external to the pointing device. In some examples, the pointing device may be able to make changes in a configuration mode without an external component. In some examples, the pointing device may be able to notify a user of changes to the configuration without an external component, such as external application and external computing devices. As used herein, an external application refers to a program or piece of software that is external from the pointing device. As used herein, an external computing device refers to an electronic equipment controlled by a central processing unit (CPU) that is external from the pointing device (e.g., computers, smartphones, tablets, display screens, eta).

In some examples, the pointing device may include a plurality of buttons to assist with the operation of the pointing device. As used herein, a button refers to a key used to operate the pointing device and initiate specific functions of a pointing device and/or computing device. In some examples, the button may be a physical button. As used herein, a physical button refers to a key that is activated by physically moving the key. In some examples, the button may be a virtual button. As used herein, a virtual button refers to a key that is activated by touching the key and/or coming into close proximity of the key. In some examples, the buttons may transition the pointing device into a configuration mode. In addition, the buttons may also transition between a plurality of configuration categories and select a configuration category while in a configuration mode. In some examples, the pointing device may indicate the configuration category by displaying a light from a light source, emitting a sound from an audio mechanism, and/or producing haptic feedback from a motor. In various examples, the buttons may transition between settings of a configuration category while in a configuration mode. In addition, the buttons may be used to select a setting within a configuration category. In some examples, the pointing device may include a scrolling mechanism to transition between a plurality of configuration categories and a plurality of settings while in a configuration mode. Accordingly, this disclosure describes pointing devices that allow for quick configuration changes without the use of external applications or external computing devices.

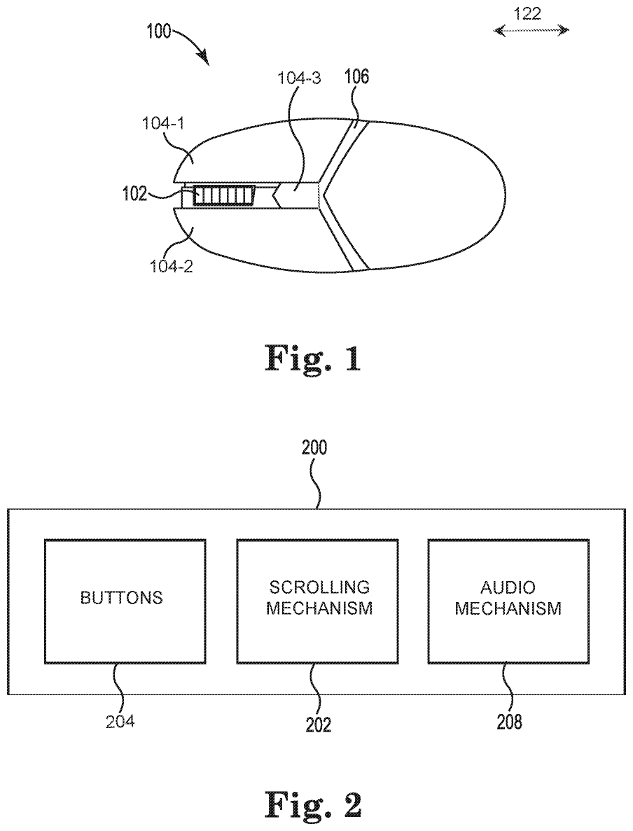

FIG. 1 illustrates an example of a pointing device 100 consistent with the disclosure. The pointing device 100 may be implemented to interact with a variety of computing devices, such as desk top computers, portable computers, tablets, etc. In some examples, the pointing device 100 may include a button 104-1, 104-2, or 104-3 connected to the body of the pointing device 100. In various examples, the pointing device 100 may include a plurality of buttons 104-1, 104-2, and/or 104-3 to assist with the operation of the pointing device 100. In some examples, the buttons 104-1, 104-2, and/or 104-3 may transition the pointing device 100 into a configuration mode. For example, the button 104-3 may be depressed or activated to initiate a configuration mode in the pointing device 100. As used herein, a configuration mode refers to a state that allows for changes and adjustment in the operation of the pointing device.

In some examples, the plurality of buttons 104-1, 104-2, and/or 104-3 allows a user to enter a configuration mode without a computing device and make changes to the configuration of the pointing device 100. That is, using the plurality of buttons 104-1, 104-2, and/or 104-3 to enter a configuration mode may allow for changes to the configuration of the pointing device 100 to be implemented quickly without an external component.

In some examples, the buttons 104-1, 104-2, and/or 104-3 may transition between the various configuration categories of the pointing device 100. For example, the buttons may transition between a plurality of configuration categories, such as, polling rate, lift off distance, amount of dots per inch (DPI), and lighting. As used herein, a configuration category is the classification of configuration content that may be adjusted. In some examples, a user may depress or activate button 104-1 to transition forward through the plurality of configuration categories and depress or activate button 104-2 to transition backwards through the plurality of configuration categories. In some examples, the buttons 104-1, 104-2, and/or 104-3 may be on the top of the pointing device 100, as illustrated in FIG. 100.

In various examples, the buttons 104-1, 104-2, and/or 104-3 may be used to select different options on a computing device. In some examples, the buttons 104-1, 104-2, and/or 104-3 may be used to select a setting of a plurality of settings within a configuration category. For example, when the pointing device 100 is in a particular configuration category the button 104-3 may be used to select a particular setting of a plurality of settings within the configuration category. As used herein, a setting refers to choices within a configuration category that may be adjusted to change the way the pointing device operates.

In some examples, the pointing device 100 may include a light source 106. In some examples, the light source 106 may be a light emitting diode. The light source 106 may be used to indicate the configuration category of the pointing device 100. For example, the light source 106 may display a different color for each configuration category of the pointing device 100. In some examples, the light source 106 is positioned on the top of the pointing device 100, as illustrated in FIG. 1. However, this disclosure is not so limited. For example, the light source 106 may be positioned on the side of the pointing device 100. In addition, the light source 106 may be positioned on the bottom of the pointing device 100. In some examples, the light source 106 may indicate a particular setting of the plurality of settings within a configuration category by displaying a flashing light. In some examples, the light source 106 may indicate a particular setting of the plurality of settings within a configuration category by displaying varying light intensities for each setting.

In some examples, the configuration of the pointing device 100 may be adjusted quickly and without the use of an external component when the light source 106 indicates the configuration category. That is, a user may be able to make quick adjustments to the configuration of the pointing device 100, while the pointing device 100 is in use, when the light source 106 indicates the configuration category. In some examples, a user may be able to make quick setting changes to the configuration category while using the pointing device 100. That is, the user may be able to effectuate a change and identify a particular setting of the plurality of settings within a configuration category based on the light source 106.

In some examples, the pointing device 100 may include a scrolling mechanism 102 connected to the body of the pointing device 100. As used herein, a scrolling mechanism refers to a mechanism that allows for moving displayed text or graphics up, down, or across on a computer screen, and/or moving through different features of a configuration mode. In some examples, the scrolling mechanism may be a scroll wheel. As used herein, a scroll wheel refers to a wheel attached to the pointing device that is activated by physically moving the wheel. In some examples, the scrolling mechanism may be a tactile sensor. As used herein, a tactile sensor refers to a senor attached to the pointing device that is activated by touch. In various examples, the scrolling mechanism 102 may assist with the operation of the pointing device 100. In some examples, the scrolling mechanism 102 may transition the pointing device 100 into a configuration mode. For example, the scrolling mechanism 102 may be held down or activated for a predetermined amount of time to initiate a configuration mode in the pointing device 100.

In various examples, the scrolling mechanism 102 may be on the top of the pointing device 100, as illustrated in FIG. 1. However, this disclosure is not so limited. The scrolling mechanism 102 may be on the side of the pointing device 100, In some examples, the scrolling mechanism 102 may transition between the various configuration categories of the pointing device 100. For example, a user may move the scrolling mechanism 102 forward or backward to transition between a plurality of configuration categories. That is, the scrolling mechanism 102 may rotate or transition in a direction as denoted by the axis 122 to transition between the plurality of configuration categories. In some examples, when the chosen configuration category is reached the scrolling mechanism 102 may be depressed or activated to select the configuration category to allow for setting changes.

In various examples, the scrolling mechanism 102 may be used to transition between a plurality of settings while the pointing device 100 is in a configuration mode. That is, when the pointing device 100 is in a particular configuration category the scrolling mechanism 102 may be used to transition between the plurality of settings in a configuration category. In some examples, the scrolling mechanism 102 may be used to select a setting of a plurality of settings within a configuration category. For example, the scrolling mechanism 102 may be depressed or activated to change the setting of a particular configuration category. In some examples, when a setting is selected the pointing device 100 may exit the configuration category. In some examples, as the pointing device 100 exits a configuration category the selected settings of the configuration category are saved to the memory of the pointing device 100.

In some examples, the scrolling mechanism 102 may allow a user to quickly maneuver through a plurality of configuration categories and a plurality of settings of a particular configuration category. That is, a user may rapidly move through a variety of configuration categories while using the scrolling mechanism 102 allowing a user to make quick adjustments to the configuration of the pointing device 100. Similarly, a user may also rapidly move through the plurality of settings of a particular configuration category, allowing a user to make quick adjustments to the configuration of the pointing device 100 without an external component.

FIG. 2 illustrates an example of a pointing device 200 consistent with the disclosure. In some examples, the pointing device 200 may include buttons 204 connected to the body of the pointing device 200. In various examples, the pointing device 200 may include a plurality of buttons 204 to perform a variety of functions. In some examples, the button 204 may be on the side of the pointing device 200. In some examples, the buttons 204 may be on the top of the pointing device 200. For example, the pointing device 200 may have a plurality of buttons 204 positioned on the side and the top of the pointing device.

In some examples, the buttons 204 may cause the pointing device 200 to enter a configuration mode, may assist with the operation of a computing device, and/or perform a variety of other functions. That is, the buttons 204 may transition the pointing device 200 into a configuration mode. For example, the buttons 204 may be held down or activated for a predetermined amount of time (e.g., no less than 2 seconds) to trigger a configuration mode and transition the pointing device 200 into a configuration mode. That is, a user may press or activate buttons 204 4 for a predetermined amount of time (e.g., no less than 2 seconds) to transition the pointing device 200 into the configuration mode. In some examples, pressing or activating the buttons 204 in a variety of different combinations may transition the pointing device 200 in to a configuration mode. For example, to enter a configuration mode the buttons 204 may pressed or activated for a time no less than 3 seconds. In some examples, pressing or activating the buttons 204 in a successive order may transition the pointing device 200 in to a configuration mode. For example, a user may press or activate buttons 204 in successive order to enter a configuration mode.

In some examples, the buttons 204 may transition between the various configuration categories of the pointing device 200. For example, button 204 may be pressed or activated to transition forward or backwards through a plurality of configuration categories. In some examples, the buttons 204 may be used to select a configuration category while the pointing device 200 is in a configuration mode.

In various examples, the buttons 204 may be used to select different options on a computing device. In various examples, the buttons 204 may be used to select a plurality of settings while in a configuration mode. That is, the buttons 204 may be used to select a particular setting of a plurality of settings within the configuration category and transition the pointing device 200 out of the selected configuration category into a main menu. As used herein, a main menu refers to the portion of the configuration mode that list the plurality of configuration categories in the configuration mode.

In some examples, the pointing device 200 may include a scrolling mechanism 202 on top of the pointing device 200. In various examples, the scrolling mechanism 202 may assist with a change in configuration while the pointing device 200 is in a configuration mode. In some examples, the scrolling mechanism 202 may transition the pointing device 200 into a main menu of the configuration mode. For example, the scrolling mechanism 202 may be pushed to the left or right side for a predetermined amount of time to initiate a configuration mode.

In some examples, the scrolling mechanism 202 may function as a button. For example, the scrolling mechanism may be pushed down or pushed to the left or right to effectuate a change. In some examples, the scrolling mechanism 202 may transition between the various configuration categories of the pointing device 200. For example, a user may cause the scrolling mechanism 202 to rotate or transition forward or backward to move between a plurality of configuration categories. In some examples, the scrolling mechanism may be pushed to the left or the right to transition between the plurality of configuration categories. In some examples, when a chosen configuration category is reached the scrolling mechanism 202 may be depressed to select the configuration category. In some examples, once a configuration category is selected the pointing device 200 may allow for the settings of the configuration category to be changed.

In various examples, the scrolling mechanism 202 may be used transition between a plurality of settings while the pointing device 200 is in a configuration mode, That is, when the pointing device 200 is in a particular configuration category the scrolling mechanism 202 may be used to transition between the plurality of settings in the particular configuration category. For example, the scrolling mechanism 202 may transition between a plurality of settings by rotating the scrolling mechanism 202 or tilting the scrolling mechanism 202 to the left or right. In some examples, the scrolling mechanism 202 may be used to select a setting of the plurality settings within a configuration category. For example, the scrolling mechanism 202 may be depressed or activated to change the setting of a particular configuration category.

In some examples, the pointing device 200 may include an audio mechanism 208. As used herein, an audio mechanism refers to an apparatus that converts electrical impulses into sound. In various examples, the audio mechanism 208 may be used to indicate the configuration category of the pointing device 200. For example, the audio mechanism 208 may emit a sound that indicates the configuration category by stating the configuration category. That is, as the scrolling mechanism 202 or the buttons 204 transition through the plurality of configuration categories the audio mechanism 208 may state the name of each configuration category.

In some examples, the audio mechanism 208 is positioned at the back of the pointing device 200.

However, this disclosure is not so limited. For example, the audio mechanism 208 may be positioned at the bottom of the pointing device 200. In addition, the audio mechanism 208 may be positioned on the side of the pointing device 200.

In some examples, the audio mechanism 208 may indicate a particular setting of a particular configuration category by stating the setting while in a particular configuration category. That is, after the configuration category has been selected and the user is transitioning between a plurality of settings the audio mechanism 208 may state the name of each setting.

In some examples, the configuration of the pointing device 200 may be adjusted quickly and without the use of an external component. That is, the pointing device 200 may utilize an audio mechanism 208 and/or a light source to identify a variety of configuration categories and make quick adjustments to the configuration of the pointing device 200. In some examples, a user may be able to make quick adjustments to the configuration while the pointing device 200 is in use. In some examples, a user may be able to make quick setting changes to the configuration category while using the pointing device 200. That is, the user may be able to identify a particular setting of a plurality of settings within a configuration category to effectuate a change based on the identification of the setting by the light source. Similarly, a user may be able to identify a particular setting within a configuration category to effectuate a change based on the identification of the setting by the audio mechanism 208.

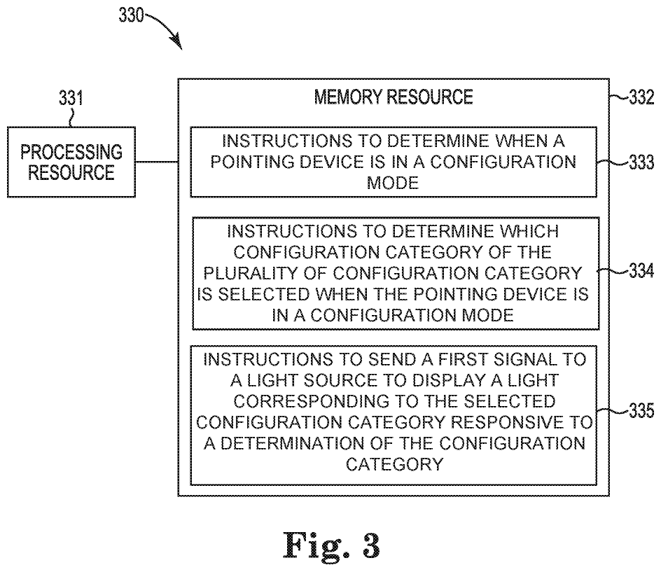

FIG. 3 illustrates an example of an apparatus 330 for a pointing device consistent with the disclosure. As illustrated in FIG. 3, the apparatus 330 includes a processing resource 331 and a memory resource 332. The processing resource 331 may be a hardware processing unit such as a microprocessor, microcontroller, application specific instruction set processor, coprocessor, network processor, or similar hardware circuitry that may cause machine-readable instructions to be executed. In some examples, the processing resource 331 may be a plurality of hardware processing units that may cause machine-readable instructions to be executed. The processing resource 331 may include central processing units (CPUs) among other types of processing units. The memory resource 332 may be any type of volatile or non-volatile memory or storage, such as random-access memory (RAM), flash memory, read-only memory (ROM), storage volumes, a hard disk, or a combination thereof.

The memory resource 332 may store instructions thereon, such as instructions 333, 334, and 335. When executed by the processing resource 331, the instructions may cause the apparatus 330 to perform specific tasks and/or functions. For example, the memory resource 332 may store instructions 333 which may be executed by the processing resource 331 to cause the apparatus 330 to determine when a pointing device is in a configuration mode. In some examples, when the pointing device is in a configuration mode, a user may be able to change the configurations of the pointing device. For example, a user may be able to select a configuration category and make changes to the selected configuration category.

The memory resource 332 may store instructions 334 which may be executed by the processing resource 331 to cause the apparatus 330 to determine which configuration category of the plurality of configuration category is selected when the pointing device is in a configuration mode. In some examples, when a configuration category is selected a user may be notified that a configuration category has been selected. For example, the light source may display a light to indicate to the user which configuration category is selected.

The memory resource 332 may store instructions 335 which may be executed by the processing resource 331 to cause the apparatus 330 to send a first signal to a light source to display a light corresponding to the selected configuration category responsive to the determination of the configuration category. For example, the light source may display a different color light for each configuration category of the pointing device. In some examples, the light source may display a different intensity of light for each configuration category of the pointing device. In some examples, the light source may flash a different number of times for each configuration category of the pointing device (e.g., the light source may flash two times to indicate the configuration category for lift off distance and flash three times to indicate the configuration category for polling rate).

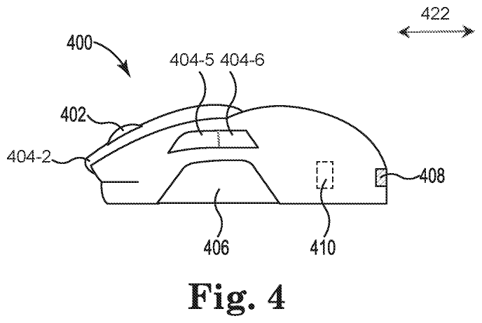

FIG. 4 illustrates an example of a pointing device 400 consistent with the disclosure. In some examples, the pointing device 400 may include buttons 404-2, 404-5, and/or 404-6 coupled to the pointing device 400. In some examples, the pointing device 400 may include a plurality of buttons 404-2, 404-5, and/or 404-6 to perform a variety of functions. In some examples, the buttons 404-5 and/or 404-6 may be on the side of the pointing device 400, as illustrated in FIG. 4. In some examples, the button 404-2 may be on the top of the pointing device 400, as illustrated in FIG. 4. For example, the pointing device 400 may have a plurality of buttons 404-5, and/or 404-6 positioned on the side of the pointing device 400, as illustrated in FIG. 4. In addition, the pointing device 400 may include a plurality of buttons (e.g., buttons 104-1, 104-2, and/or 104-3 of FIG. 1) on the top of the pointing device 400.

It should be understood that when an element is referred to as being “on,” “in contact,” “connected to”, “coupled to”, or “coupled with” another element, it may be directly on, in contact, connected, or coupled with the other element or intervening elements may be present. In contrast, when an object is “directly coupled to” or “directly coupled with” another element it is understood that are no intervening elements (adhesives, screws, other elements) etc.

In some examples, an individual button 404-2, 404-5, or 404-6 may cause the pointing device 400 to enter a configuration mode or exit a configuration mode. That is, the button 404-2, 404-5, or 404-6 may transition the pointing device 400 into the main menu of a configuration mode. For example, the button 404-5 may be held down or activated for a predetermined amount of time (e.g., a time no less than 1 second) to cause the pointing device 400 to enter a configuration mode. In some examples, the button 404-5 may be pressed or activated multiple times to enter the pointing device 400 into a configuration mode. In some examples, a plurality of buttons 404-2, 404-5, and/or 404-6 may transition the pointing device 400 into a configuration mode. For example, a user may press and hold down both buttons 404-5 and 404-6 for a predetermined amount of time to transition the pointing device 400 into the configuration mode. In some examples, activating the buttons 404-2, 404-5, and/or 404-6 in a variety of different combinations may transition the pointing device 400 in to a configuration mode.

In some examples, an individual button 404-2, 404-5, or 404-6 may transition the pointing device 400 out of a configuration mode. For example, while in the configuration mode, the button 404-2, 404-5, or 404-6 may be held down or activated for a predetermined amount of time (e.g., a time no less than 1 second) to cause the pointing device 400 to exit a configuration mode. In some examples, a plurality of buttons 404-2, 404-5, and/or 404-6 may transition the pointing device 400 out of a configuration mode. That is, a user may press or activate buttons 404-2 and/or 404-6, while in a configuration mode, for a predetermined amount of time (e.g., a time no less than 1 second) to transition the pointing device 400 out of a configuration mode. In some examples, activating the buttons 404-2, 404-5, and/or 404-6 in a variety of different combinations may transition the pointing device 400 out of a configuration mode. In some examples, as the pointing device 400 exits the configuration mode, selected settings and changes are saved to the memory of the pointing device 400.

In some examples, the buttons 404-2, 404-5, and/or 404-6 may transition between the various configuration categories of the pointing device 400. For example, a user may depress or activate button 404-5 to transition forward through a plurality of configuration categories and depress or activate button 404-6 to transition backwards through the plurality of configuration categories. In some examples, the buttons 404-2, 404-5, and/or 404-6 may be used to select a configuration category while the pointing device 400 is in a configuration mode. For example, the buttons 404-2, 404-5, and/or 404-6 may select a configuration category by being pressed or activated multiple times within a predetermined amount of time (e.g., ⅓ of a second). In some examples, the pointing device 400 may comprise a variety of configuration categories. That is, the plurality of configuration categories of the pointing device 400 may include polling rate, lift off distance, amount of dots per inch (DPI), types of lighting, etc.

In some examples, the button 404-2, 404-5, and/or 404-6 may transition between the various setting of a configuration category of the pointing device 400. For example, a user may activate button 404-5 to transition forward through the plurality of settings in a configuration category and activate button 404-6 to transition backwards through the plurality of settings of the configuration category. In various examples, the buttons 404-2, 404-5, and/or 404-6 may be used to select a setting of a plurality of settings while in a configuration mode. That is, when the pointing device 400 is in a particular configuration category the buttons 404-2, 404-5, and/or 404-6 may be used to select a particular setting within the configuration category.

In some examples, the pointing device 400 may include a scrolling mechanism 402 on top of the pointing device 400, as illustrated in FIG. 4. In various examples, the scrolling mechanism 402 may assist with a configuration change while the pointing device 400 is in a configuration mode. In some examples, the scrolling mechanism 402 may function as a button. In some examples, the scrolling mechanism 402 may transition the pointing device 400 into a configuration mode. For example, the scrolling mechanism 402 may be pushed down, left or right for a time no less than 3 seconds to initiate a configuration mode.

While some elements are designated as a “top” or a “bottom” and/or “front” or “back,” it should be understood that such elements may correspond to other relative terms or possible orientations in some applications in order to practice the examples of this disclosure.

In some examples, the scrolling mechanism 402 may transition between the various configuration categories of the pointing device 400. For example, a user may rotate the scrolling mechanism 402 forward or backward to transition between a plurality of configuration categories. That is, the scrolling mechanism 402 may be rotated in a direction as denoted by the axis 422 to transition between the plurality of configuration categories. In some examples, the scrolling mechanism 402 may be pushed to the left or the right to transition between the plurality of configuration categories. In some examples, when a chosen configuration category is reached the scrolling mechanism 402 may be depressed or activated to select the configuration category and transition into setting selection.

In various examples, the scrolling mechanism 402 may be used to transition between a plurality of settings while the pointing device 400 is in a configuration mode. That is, when the pointing device 400 is in a particular configuration category the scrolling mechanism 402 may be used to transition between the plurality of settings in the particular configuration category. In some examples, the scrolling mechanism 402 may be used to select a setting within a configuration category.

In some examples, the pointing device 400 may include an audio mechanism 408. In some examples, the audio mechanism 408 is positioned at the back of the pointing device 400, as illustrated in FIG. 4. In various examples, the audio mechanism 408 may be used to indicate the configuration category of the pointing device 400. For example, the audio mechanism 408 may emit a sound that indicates the configuration category. That is, as the scrolling mechanism 402 or the buttons 404-2, 404-5, and/or 404-6 transition through the plurality of configuration categories the audio mechanism 408 may state the name of each configuration category.

In some examples, the audio mechanism 408 may indicate a particular setting of a configuration category by stating the name of the setting. In some examples, as the pointing device 400 exits the configuration category the audio mechanism may state the selected setting and save the changes to the pointing device 400.

In some examples, the pointing device 400 may include a light source 406. In various examples, the light source 406 may be used to indicate the configuration category of the pointing device 400. For example, the light source 406 may pulse in varying patterns to indicate the configuration category while in a configuration mode. In some examples, the light source 406 may be positioned on the side of the pointing device 400, as illustrated in FIG. 4. However, this disclosure is not so limited. For example, the light source 406 is positioned on the top of the pointing device 400 (e.g., light source 106 of FIG. 1). In some examples, the light source 406 may indicate a particular setting of a particular configuration category by displaying different color lights. In some examples, the light source 406 may indicate a particular setting of a particular configuration category by displaying varying light intensities for each setting. In some examples, the light source 406 may pulse in varying patterns to indicate a particular setting of the configuration category while in a configuration mode.

In some examples, the pointing device 400 may include a motor 410. In some examples, the motor 410 may be disposed inside of the pointing device 400. In some examples, the motor 410 may be used to indicate the configuration category of the pointing device 400. For example, the motor may provide haptic feedback to indicate the configuration category while the pointing device 400 is in a configuration mode. That is, the pointing device 400 may vibrate to indicate the configuration category while in a configuration mode. For example, the motor 410 may cause the pointing device 400 to vibrate in varying pulse patterns to indicate the configuration category while in a configuration mode. In some examples, the configuration of the pointing device 400 may be adjusted quickly and without the use of an external component. That is, the pointing device 400 may utilize a motor 410 to generate haptic feedback to identify a variety of configuration categories to make quick adjustments to the configuration of the pointing device 400.

In some examples, the motor 410 may cause the pointing device 400 to vibrate when the pointing device 400 enters a configuration mode. Likewise, the motor 410 may cause the pointing device 400 to vibrate when the pointing device 400 exits the configuration mode. In some examples, the motor 410 may cause the pointing device 400 to vibrate when a configuration category has been selected. Similarly, the motor 410 may cause the pointing device 400 to vibrate when a setting within a configuration category has been selected. In some examples, the pointing device 400 may vibrate to indicate the settings of the configuration category while in a configuration mode. That is, the user may be able to identify a particular setting within a configuration category and effectuate a change based on the identification of the setting by the haptic feedback from the motor 410.

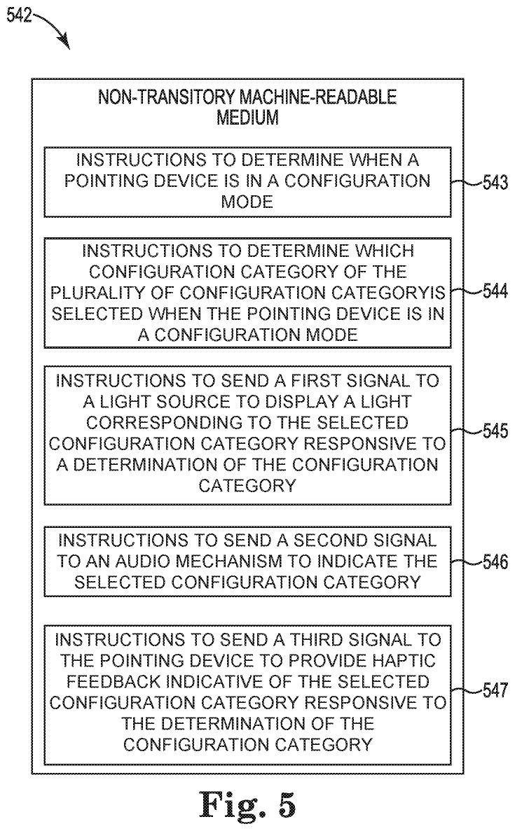

FIG. 5 illustrates an example diagram of a medium 542 for a pointing device consistent with the disclosure. A processing resource may execute instructions stored on the non-transitory machine readable medium 542. The non-transitory machine readable medium 542 may be any type of volatile or non-volatile memory or storage, such as random-access memory (RAM), flash memory, read-only memory (ROM), storage volumes, a hard disk, or a combination thereof.

The medium 542 stores instructions 543 executable by a processing resource to determine when a pointing device is in a configuration mode. In some examples, when the pointing device is in a configuration mode, a user may be able to change the configurations of the pointing device. For example, a user may be able to select a configuration category and change the settings of the selected configuration category.

The medium 542 stores instructions 544 executable by a processing resource to determine which configuration category of the plurality of configuration categories is selected when the pointing device is in the configuration mode. In some examples, when a configuration category is selected a user may be notified in a variety of different ways. For example, the pointing device may vibrate, a light source may display a light, or an audio mechanism may emit a sound.

The medium 542 stores instructions 545 executable by a processing resource to send a first signal to a light source to display a light corresponding to the selected configuration category responsive to the determination of the configuration category. For example, the light source may display a different color light for each configuration category of the pointing device. In some examples, the light source may display a different intensity of light for each configuration category of the pointing device. In some examples, the light source may flash in different patterns for each configuration category.

The medium 542 stores instructions 546 executable by a processing resource to send a second signal to an audio mechanism to indicate the selected configuration category. For example, the audio mechanism may indicate the configuration category by stating which configuration category the pointing device is in.

The medium 542 stores instructions 547 executable by a processing resource to send a third signal to the pointing device to provide haptic feedback indicative of the selected configuration category responsive to the determination of the configuration category. For example, a motor disposed inside the pointing device may vibrate in varying patterns to indicate the selected configuration category.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

It should be understood that the descriptions of various examples may not be drawn to scale and thus, the descriptions may have a different size and/or configuration other than as shown therein.

What is claimed:

1. A pointing device comprising:
a plurality of buttons disposed on a body;
a scrolling mechanism to transition between a plurality of configuration categories when the pointing device is in a configuration mode; and
a light source to indicate a selected configuration category of the plurality of configuration categories when the pointing device is in the configuration mode.

2. The pointing device of claim 1, wherein the pointing device is to enter the configuration mode without an external component by activating a button of the plurality of buttons of the pointing device.

3. The pointing device of claim 2, wherein the pointing device is to exit the configuration mode and save selected settings by activating the button of the pointing device.

4. The pointing device of claim 1, comprising an audio mechanism to emit a sound to indicate the selected configuration category of the pointing device when the pointing device is in the configuration mode.

5. The pointing device of claim 1, wherein each configuration category of the pointing device is indicated by a different color of the light source.

6. The pointing device of claim 1, wherein a button of the plurality of buttons is to select the configuration category of the pointing device when the pointing device is in the configuration mode.

7. The pointing device of claim 1, wherein the plurality of configuration categories include a polling rate, a lift off distance, an amount of dots per inch (DPI), a type of lighting, or combinations thereof.

8. A pointing device comprising:
buttons to transition the pointing device into a configuration mode;
a scrolling mechanism to transition between a plurality of settings when the pointing device is in the configuration mode; and
an audio mechanism to emit a sound to indicate a setting of the plurality of settings when the pointing device is in the configuration mode.

9. The pointing device of claim 8, further comprising a motor to provide haptic feedback to indicate the setting of a configuration category when the pointing device is in the configuration mode.

10. The pointing device of claim 8, wherein the buttons are to select a configuration category of the pointing device when the pointing device is in the configuration mode.

11. The pointing device of claim 10, further comprising a light source to indicate the setting of the configuration category when the pointing device is in the configuration mode.

12. The pointing device of claim 8, further comprising a light source to indicate a configuration category by flashing a different number of times for each configuration category.

13. A non-transitory machine-readable medium storing instructions that, when executed by a processing resource, cause the processing resource to:
determine when a pointing device is in a configuration mode;
determine which configuration category of a plurality of configuration categories is selected when the pointing device is in the configuration mode; and
send a first signal to a light source to display a light corresponding to the selected configuration category responsive to the determination of the configuration category.

14. The medium of claim 13, storing instructions to send a second signal to an audio mechanism to indicate the selected configuration category responsive to the determination of the configuration category.

15. The medium of claim 14, storing instructions to send a third signal to the pointing device to provide haptic feedback indicative of the selected configuration category responsive to the determination of the configuration category.
